(19) United States
(12) Patent Application Publication
(10) Pub. No.: US 2007/0013200 A1
(43) Pub. Date: Jan. 18, 2007

(54) Pillar cover for vehicle

(75) Inventors: Tsutomu Totani, Nagoya-shi (JP); Yasuo Serikawa, Nagoya-shi (JP)

Correspondence Address: KODA & ANDROLIA, 2029 CENTURY PARK EAST, SUITE 1140, LOS ANGELES, CA, 90067, US

(73) Assignee: Beat-Sonic Co., Ltd.

(21) Appl. No.: 11/439,329

(22) Filed: May 22, 2006

(30) Foreign Application Priority Data
Jul. 12, 2005 (JP) 2005-202924

(51) Int. Cl. B60J 9/00

(52) U.S. Cl. 296/1.07

(57) ABSTRACT

A pillar cover mounted to a pillar of a vehicle so that a space is defined between the pillar and the pillar cover and so that a vehicle electronic device is mounted in the space. The vehicle electronic device may comprise an audio and video device, a car navigation unit, a car radar unit, a car security alarm system, or an electronic toll collection (ETC) system. When the pillar cover is mounted to the pillar at the driver's seat side, the driver turns sight line slightly sideways so that the vehicle control electronic device can be perceived and accordingly, the device can be operated safe and reliably.

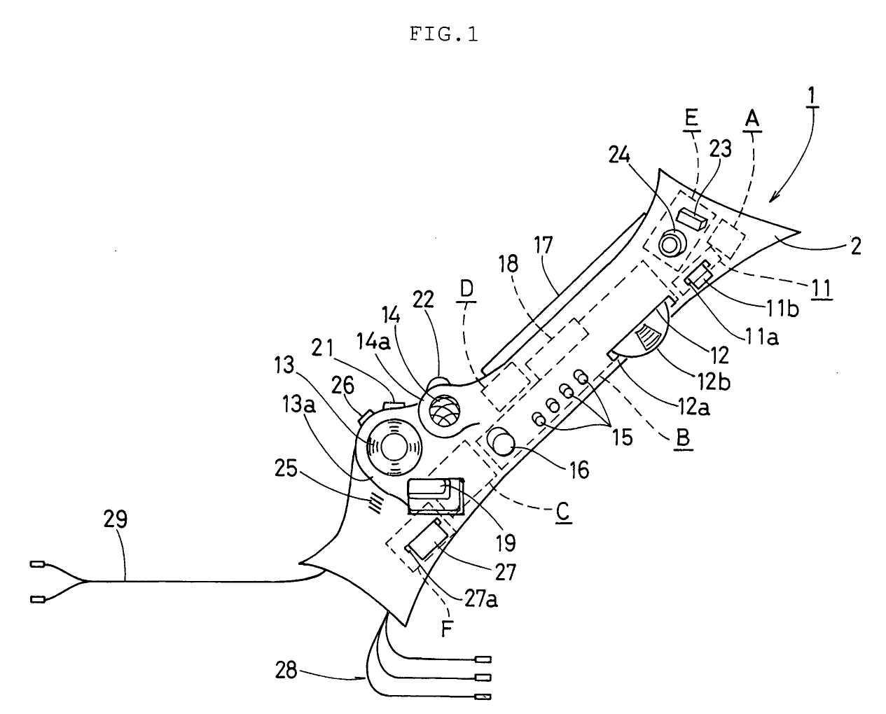

### CROSS-REFERENCE TO RELATED APPLICATIONS

This application is based upon and claims the benefit of priority from the prior Japanese Patent Application No. 2005-202924, filed on Jul. 12, 2005, the entire contents of which are incorporated herein by reference.

### BACKGROUND OF THE INVENTION

1. Field of the Invention

The present invention relates to a pillar cover mounted to a pillar of a vehicle.

2. Description of the Related Art

A substantial amount of space is defined between a pillar and a pillar cover mounted on the pillar in vehicles. JP-A-2001-218289 proposes loud speakers incorporated in the space between a pillar and a pillar cover. However, providing a vehicle electronic device in the space between the pillar and the pillar cover has never hitherto been found.

On the other hand, a pillar at the driver's seat side of a vehicle is located at such a position that a driver can easily reach for the pillar. Accordingly, if the vehicle electronic device were provided in the space between the pillar and the pillar cover, the driver could reach for the vehicle electronic device and accordingly, such provision of the vehicle electronic device would be suitable for the operation by the driver.

### SUMMARY OF THE INVENTION

Therefore, an object of the present invention is to provide a pillar cover which can be mounted to a pillar and allow a vehicle electronic device to be provided in the space defined between the pillar and the pillar cover mounted to the pillar.

The present invention provides a pillar cover mounted to a pillar of a vehicle so that a space is defined between the pillar and the pillar cover and so that a vehicle electronic device is provided in the space.

The vehicle electronic device comprises a car audio-visual system, a car navigation unit, a car radar unit, a car security alarm system, or an electronic toll collection (ETC) system.

When the pillar cover is mounted to the pillar at the driver's seat side, the driver turns sight line slightly sideways so that the vehicle electronic device can be perceived and accordingly, the device can be operated safe and reliably.

In another embodiment, the vehicle electronic device comprises a vehicle control electronic device. Consequently, the vehicle control electronic device can be prevented from water immersion even when a lower half of the vehicle is submerged in water in disaster situations such as rain-swollen creek.

### BRIEF DESCRIPTION OF THE DRAWINGS

Other objects, features and advantages of the present invention will become clear upon reviewing the following description of the embodiment with reference to the accompanying FIGURE which is a front view of a pillar cover in accordance with one embodiment of the present invention.

### DETAILED DESCRIPTION OF THE INVENTION

One embodiment of the present invention will be described with reference to the accompanying FIGURE. Referring to the FIGURE, a pillar cover 1 of the embodiment is shown. The pillar cover 1 is mounted to a pillar standing between a front window and a front door frame at a driver's seat side. The pillar cover 1 is made from a synthetic resin and a leather cover is affixed to the surface of the pillar cover 1.

A space is defined between the pillar cover 1 and the pillar. In the space are provided a vehicle control electronic device A, a car audio-visual system B, a car navigation unit C, a car radar unit D, a car security alarm system E, or an electronic toll collection (ETC) system F.

The vehicle control electronic device A is an electronic control unit for control of power train such as engine control or transmission control, vehicle control such as suspension control or anti-lock brake system (ABS) control, or body control such as wiper control or light control. Since these control units or devices are provided in the space defined between the pillar cover 1 and the pillar, the vehicle control electronic device can be prevented from water immersion even when a lower half of the vehicle is submerged in water in disaster situations such as rain-swollen creek.

Furthermore, the car audio-visual system B comprises a memory audio player 11, a CD/DVD player 12, a loud speaker 13, a tweeter 14, various operation switches 15, a volume switch 16, a TV/FM antenna 17, an amplifier, a tuner and the like. For use of the memory audio player 11, a flash memory 11b is inserted into an insertion slot formed in the pillar cover 1. Furthermore, a compact disc (CD) or digital versatile disc (DVD) 12b is inserted into an insertion slot 12a formed in the pillar cover 1. The loud speaker 13 and tweeter 14 are provided in expanded portions 13a and 14a formed in predetermined portions of the pillar cover 1 respectively. The operation switches 15 and volume switch 16 protrude toward the driver's seat side. A liquid-crystal monitor 19 is also provided for displaying various pieces of information, image information and the like.

The car navigation unit C includes a global positioning system (GPS) antenna 21 which protrudes from the expanded portion 13a in which the loud speaker 13 is provided. The car radar unit D includes an internal detection circuit and a radar antenna 22 which is directed to the front of the vehicle and protrudes from the expanded portion 14a of the tweeter 14. The car security alarm system E comprises an infrared human body sensor 23 and a monitor camera 24 both of which are disposed on an upper part of the pillar cover 1 as shown in the FIGURE. The car security alarm system E further comprises a security alarm 25 disposed on a lower part of the pillar cover 1.

Furthermore, the electronic toll collection (ETC) system F includes an internal ETC circuit (not shown) and an ETC antenna 26 protruding from the aforesaid expanded portion 13a. The pillar cover 1 is formed with a card insertion slot 27a into which an ETC card 27 is adapted to be inserted. A wire harness 28 is provided for connecting the aforesaid units or devices to a power supply (not shown). Another wire harness 29 is provided for delivering audio signals to a loud speaker and tweeter provided on another pillar cover (not shown) which is paired with the pillar cover 1 and is provided at the passenger's seat side.

When the above-described pillar cover 1 is mounted to the driver's seat side pillar of the vehicle, the driver turns sight line slightly sideways so that the vehicle electronic devices can be perceived and accordingly, the devices can be operated safe and reliably. Furthermore, the vehicle control electronic device A can be prevented from water immersion even when a lower half of the vehicle is submerged in water in disaster situations such as rain-swollen creek. Additionally, the above-described systems and devices B to F have conventionally been disposed on an instrument panel or near the instrument panel. However, since the systems and devices B to F are incorporated in the space between the pillar and the pillar cover 1 in the embodiment, the utility value of the instrument panel or the space around the instrument panel can be increased.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

We claim:

1. A pillar cover mounted to a pillar of a vehicle so that a space is defined between the pillar and the pillar cover and so that a vehicle electronic device is provided in the space.

2. The pillar cover according to claim 1, wherein the vehicle electronic device comprises an audio and video device.

3. The pillar cover according to claim 1, wherein the vehicle electronic device comprises a car navigation unit.

4. The pillar cover according to claim 1, wherein the vehicle electronic device comprises a car radar unit.

5. The pillar cover according to claim 1, wherein the vehicle electronic device comprises a car security alarm system.

6. The pillar cover according to claim 1, wherein the vehicle electronic device comprises an electronic toll collection (ETC) system.

7. The pillar cover according to claim 1, wherein the vehicle electronic device comprises a vehicle control electronic device.
